(19) United States
(12) Patent Application Publication
(10) Pub. No.: US 2022/0396334 A1
(43) Pub. Date: Dec. 15, 2022

(54) FLOTATION DEVICE FOR SUPPORTING A COFFIN HUNTING BLIND

(71) Applicant: Lane McKellar, Layton, UT (US)

(72) Inventor: Lane McKellar, Layton, UT (US)

(21) Appl. No.: 17/840,999

(22) Filed: Jun. 15, 2022

Related U.S. Application Data
(60) Provisional application No. 63/210,912, filed on Jun. 15, 2021.

(51) Int. Cl. B63B 7/08; A01M 31/02; B63B 5/24

(52) U.S. Cl. CPC B63B 7/085; A01M 31/025; B63B 5/24; B63B 2005/242

(57) ABSTRACT

An inflatable support for a coffin blind is disclosed. The support aids hunters in utilizing a coffin blind in deeper waters. The support includes an oblong body that has an opening in which a coffin blind can be inserted. The support can be made of a durable drop stitched material, and can have additional attachments. These attachments can include a site to connect an anchor, straps for supporting the blind, containers for accessories, flaps, padding for comfort, and transportation attachments.

### CROSS REFERENCE TO RELATED APPLICATION

This application claims the benefit of U.S. Provisional Application No. 63/210,912 which was filed on Jun. 15, 2021, the contents of which are hereby incorporated by reference in their entirety.

### BACKGROUND

Hunting blinds can be useful in order to avoid detection when waterfowl hunting, and to prevent the difficulties with the alternative of wading in mud. One common hunting blind for waterfowl takes the form of a camouflaged tent enclosure. More simple hunting blinds for waterfowl include layout blinds, which are depressions dug by hunters in which they hide. The coffin blind is a relatively recently developed layout-style blind that allows the hunter to hide at the water level. Typically the coffin blind is similar to a small boat made without a keel and rests on the bottom below the water level rather than floating. These blinds are highly effective for waterfowl hunting in very shallow waters.

### SUMMARY

An inflatable coffin blind support can be used to increase the effectiveness of coffin blinds in deeper waters. By supporting the coffin blind, the device can be taken into deeper waters without fear of sinking or capsizing. A flotation device for supporting a coffin-style hunting blind can include a balancing support body and an opening. The balancing support body can have an oblong shape with an elongated longitudinal axis. The balancing support body can also be inflatable. The opening is adapted to support a coffin-style hunting blind along the elongated longitudinal axis.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a top perspective view of a floatation device according to one example of the present disclosure.

FIG. 2A is a perspective view of the flotation device of FIG. 1 with flaps in a stowed position, and FIG. 2B is a perspective view of the floatation device of FIG. 1 with flaps in a deployed position.

FIG. 3 is a perspective view of the flotation device of FIG. 1 with transportation accessories.

FIG. 4 is a top perspective view of the flotation device of FIG. 1 with a coffin blind inserted in the opening.

FIG. 5A shows the flotation device and coffin hunting blind in use, and

FIG. 5B shows a hunter in a firing position.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a valve” includes reference to one or more of such mechanisms and reference to “subjecting” refers to one or more such steps.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, and combinations of each.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Flotation Device for Supporting a Coffin Hunting Blind

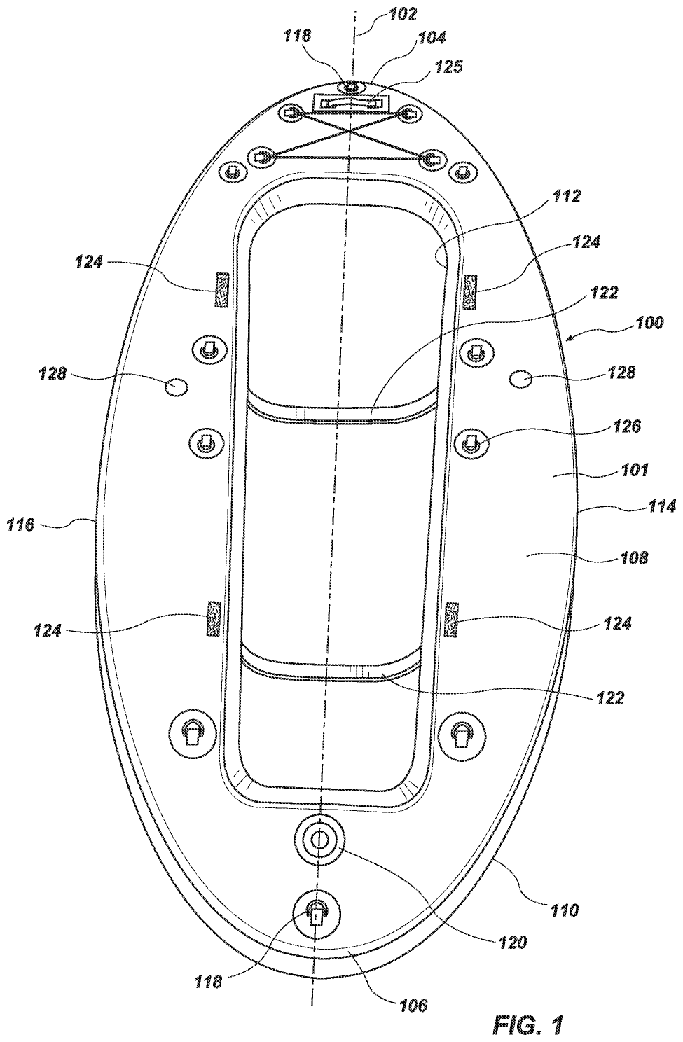

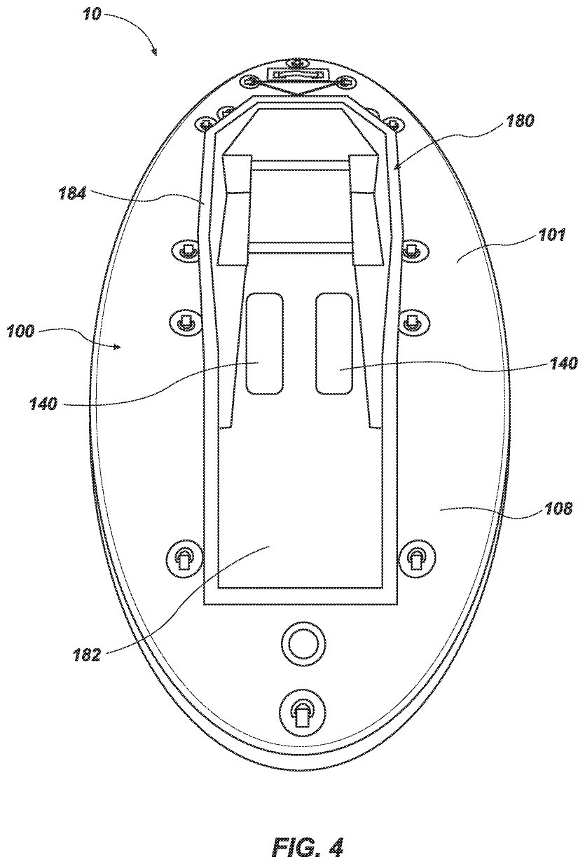

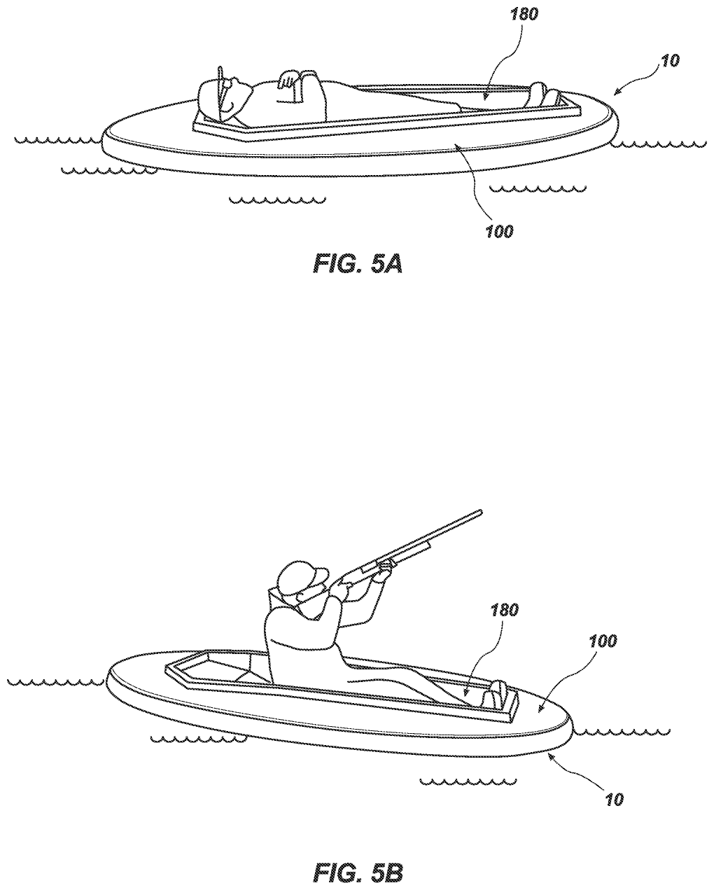

The examples described in the present disclosure provide a flotation support for coffin blinds which are commonly limited to use in shallow waters. This can allow a coffin blind to also be used in deeper waters, thus expanding the range of use for coffin blinds while simultaneously ensuring the safety of using coffin blinds in deeper waters, such as by mitigating sinking or capsizing risks. Accordingly, as shown in FIG. 1, a flotation device 100 can include a balancing support body 101 that comprises an opening 112. The opening 112 can be operable to receive and support a coffin-style hunting blind 180 therein (see, e.g. FIGS. 4-5B). The support body 101 can have an oblong shape with an elongated longitudinal axis 102. The balancing support body 101 can also be inflatable. The opening 112 can be adapted to support a coffin-style hunting blind 180 along the elongated longitudinal axis 102. The coffin blind 180 can be placed within the support body 101, at which point the hunter can utilize the coffin blind (see, e.g. FIGS. 4-5B).

As shown in FIG. 1, in one example the balancing support body 101 is generally planar. Although dimensions can vary, as a general guideline, dimensions of 6.5 feet to 9 feet in length (i.e. a direction parallel to the longitudinal axis 102 extending from a first end or bow 104 to a second end or stern 106 of the support body 101), 2 feet to 4.5 feet in width (i.e. a direction perpendicular to the longitudinal axis 102 extending from a first side or starboard side 114 to a second side or port side 116 of the support body 101), and 1.5 inches to 4 inches, and in some case up to 6 inches, in thickness (i.e. a direction extending perpendicular to the longitudinal axis 102 extending from a top side 108 to the bottom side 110 of the support body 101) can be suitable.

In one example, the balancing support body 101 can be constructed from durable polymer fabrics. Non-limiting examples of polymer fabrics can include neoprene, polyethylene, or composites thereof. The fabrics can be laminated and/or drop stitched to provide a rugged durability needed for inflatables used in hunting conditions. The fabric permits the support body to withstand heat, cold, travel, scraping against the soil, and rough waters. Exemplary thicknesses of the polymer fabric can generally range from about 0.4 to 2 mm, and often about 1.5 mm. In some examples, the balancing support body 101 can include one or more colors or pigments to provide camouflage. For example, the balancing support body 101 can provide a desired visual impression and can include camouflage pattern, sky blue, brown, or other color(s) which may match a particular body of water and/or foliage growing within or around the body of water.

The balancing support body 101 can also include an anchor loop 118 by which an anchor can be attached by a rope, chain, or other anchor line. The anchor can additionally help keep the coffin blind and support body stable and stationary rather than drift with water currents. The anchor loop 118 can be positioned on the top side 108 of the support body 101 in some examples. An anchor loop 118 can be placed near the bow 104 or the stern 106 of the support body 101. An anchor loop 118 can also be placed near both the bow 104 and the stern 106 of the support body 101. The anchor loop 118 additionally can be used to attach the flotation device 100 to other vehicles for transport or to attach to other floating devices (e.g. a second balancing support body, boat, supply tug, or the like).

The balancing support body 101 can comprise a water tight valve 120 through which the balancing support body 101 can be inflated and deflated. The water tight valve 120 can be any suitable valve used for water inflatables as are currently known. The valve can accommodate a variety of inflation methods across different examples, from automated inflation to manual pumping.

Some examples of the balancing support body 101 can include support straps 122 in various configurations that cross the opening 112 of the balancing support body 101 to support an inserted coffin blind. For example, one or more support straps 122 can be secured to a bottom side 110 of the support body 101 and can span the opening 112 so as to stabilize the hunting blind when inserted into the opening 112. In one example, the support straps 122 can be attached to a bottom side 110 of the support body 101 and can extend in a direction generally perpendicular to the longitudinal axis 102 from the starboard side 114 to the port side 116 to span the opening 112.

Alternatively, or in addition, the balancing support body 101 can comprise attachment points 124 to which the coffin blind can be attached to the flotation device 100. The attachment points 124 can comprise hook and loop fasteners, clips, or other fasteners and/or adhesives that attach to corresponding fasteners and/or adhesives of the coffin blind. In one examples, attachment points 124 as hook and loop attachments can be secured along a perimeter of the opening 112 so as to secure the hunting blind in a fixed position relative to the balancing support body 101. In another example, attachment points 124 as plastic clips can be spaced along a perimeter of the opening 112 so as to secure the hunting blind in a fixed position relative to the balancing support body 101. The balancing support body 101 can also include a plurality of loops 126 that can be operable to secure the coffin blind to the flotation device 100 by way of ropes or lines. The loops 126 can be spaced along a perimeter of the opening 112. In this case, rope or another line can be inserted through the loops 126 and used to secure the coffin hunting blind in a fixed position relative to the balancing support body 101. However, in some cases the opening 112 and interface with the coffin blind can be sufficiently complementary to allow the coffin blind to securely rest within the opening (e.g. portions of or the entire outer flange of the coffin blind can rest along an inner edge of the opening 112).

In various examples, the opening 112 in the balancing support body 101 that accommodates a coffin blind can range from 75-100 inches in longitudinal length and from 25-50 inches in latitudinal width. The opening may be generally rectangle or tapered similar to a coffin shape. For example, a width of the opening 112 can be wider towards the bow 104 of the balancing support body 101 to accommodate a wider, shoulder portion of the coffin blind.

Additionally, in some examples, the balancing support body 101 can add useful comfort and functionality by way of recessed containers 128 built into the top side 108 of the balancing support body 101. The recessed containers 128 can comprise pockets, plastic cavities, or the like, and can be used for storage. Non-limiting examples of items that can be stored in the recessed containers 128 include anchors, cups, guns, duck calls, ammunition, optics, oars, knives, rope and food.

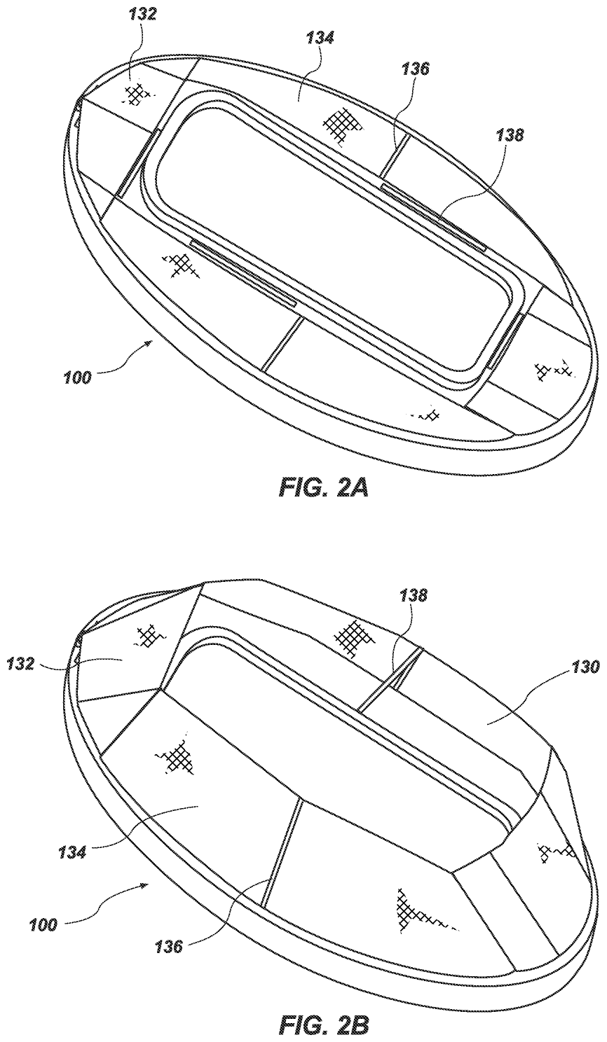

In another optional aspect shown in FIGS. 2A and 2B, the flotation device can include a camouflage barrier 130 to help prevent the hunter from being detected by game. As one example, the camouflage barrier 130 can include one or more flaps, such as end flaps 132 and side flaps 134. These flaps can be fabric or mesh flaps. In some examples these fabric flaps come with detachable poles 138 to support the camouflage barrier 130, allowing the hunter to create a small open space within the blind. Such additional open space can allow the user additional space to move or store items while waiting. These flaps 132, 134 can be used for camouflage and for weather protection. In some examples they are colored or covered with designs to aid in camouflage. In other examples the flaps have heat reflective coating to provide shielding from heat. As shown in FIG. 2A, the flaps 132, 134 can be in a stowed position lying flat against the flotation device. When the camouflage barrier is desired, the flaps 134 can be moved to a deployed position as shown in FIG. 2B by lifting the flaps 132, 134 and supporting the flaps 132, 134 with the detachable poles 138. The flaps 132, 134 can be joined at seams 136, such as via zippers or other fasteners. In some examples, the flaps 132, 134 can be permanently joined at seams 136 and can unfold from the stowed position to the deployed position.

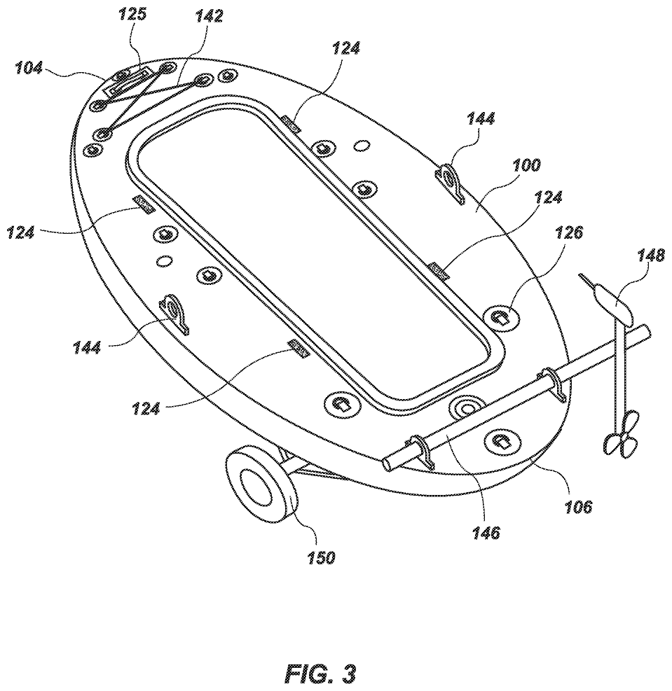

FIGS. 3 and 4 show the flotation device with other various accessories for comfort and transportation. As shown in FIG. 4, some examples comprise inflatable or foam bodies 140 that can be oriented within the coffin blind 180 as padding for additional comfort. Some inflatable or foam bodies 140 can be releasably or permanently attached to the coffin blind 180.

Other additions to the balancing support body 101 in some examples is that of attachments for transport. In some examples, the loops 126 and anchor loops 118 can also be operable as transportation points by which the support can be bound or moved. Additional, non-limiting examples of transport attachments can include detachable wheels 150. The wheels can facilitate transport of the flotation device 100 or land when moving to or from water. In another example, a motor attachment such as a trolling motor mount 146 can be provided to attach a trolling motor 148 to propel the flotation device through the water. The balancing support body can also comprise a pair of oar attachments 144 through which oars or poles can be inserted and retained.

The flotation device 100 can also be provided together with a removable, inserted coffin blind 180 as one cohesive low profile flotation hunting system 10. The coffin blind 180 can typically include a main body 182 having a length and a width, and an upper perimeter flange 184. The perimeter flange 184 can generally extend outward from the main body 182 about 0.25 to 1.5 inches allowing the perimeter flange 184 to interface with the edge of the opening 112 of the flotation device 100. The opening 112 can be sized to allow insertion of the coffin blind and can generally be 0.05 to 0.5 inches wider than the outer dimensions of the coffin blind. In this manner, the coffin blind 180 can be at least partially supported within the opening 112 by a bottom surface of the perimeter flange 184 resting along the top side 108 of the balancing support body adjacent to the opening 112.

FIG. 5A illustrates a hunter laying prone within the coffin blind 180. In this case, the coffin blind 180 has been inserted into the opening of the flotation device 100. In this position the hunter can observe surroundings while maintaining a low profile (i.e. less than about 1.5 feet from a surface of the water, and in some cases less than about 1 foot). Upon observing potential target game, the hunter can rise to a shooting position as shown in FIG. 5B.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A flotation device for supporting a coffin-style hunting blind comprising:
a balancing support body which has an oblong shape having an elongated longitudinal axis, and is inflatable; and
an opening adapted to support a coffin-style hunting blind along the elongated longitudinal axis.

2. The device of claim 1, wherein the balancing support body is generally planar.

3. The device of claim 2, wherein the balancing support body has a longitudinal length of 6.5 feet to 11 feet, a width of 2 feet to 6 feet, and a thickness of 1.5 inches to 4 inches, and wherein a longitudinal dimension of the opening ranges from 75-100 inches and a latitudinal dimension of the opening ranges from 25-50 inches.

4. The device of claim 1, wherein the balancing support body is formed of a durable laminated polymer fabric comprising one or more of neoprene, polyethylene, or a composite that is drop stitched.

5. The device of claim 1, wherein the balancing support body is colored with pigmentation or designs so as to provide camouflage.

6. The device of claim 1, further comprising an anchor loop located on a top side of the device, wherein the anchor loop is sized to accommodate a rope in order to attach to another vehicle.

7. The device of claim 1, further comprising a water-tight valve disposed on an upper or side surface of the balancing support body and through which the device can be inflated.

8. The device of claim 1, further comprising at least one support strap secured to a bottom surface of the support body and spanning the opening so as to stabilize the hunting blind.

9. The device of claim 1, further comprising hook and loop attachments along a perimeter of the opening so as to secure the hunting blind in a fixed position relative to the balancing support body.

10. The device of claim 1, further comprising loops spaced along a perimeter of the opening such that rope can be used to secure the hunting blind in a fixed position relative to the balancing support body.

11. The device of claim 1, further comprising recessed containers adapted to hold accessories.

12. The device of claim 1, further comprising a waterproof, camouflage barrier to protect a hunter within the coffin-style hunting blind from detection by game.

13. The device of claim 12, wherein the camouflage barrier comprises one or more flaps made from fabric or mesh.

14. The device of claim 13, further comprising one or more detachable poles to support the flaps to create an open space within the blind.

15. The device of claim 1, further comprising additional smaller inflatable bodies that are orientable within the coffin blind as padding.

16. The device of claim 1, further comprising foam bodies which are orientable within the coffin blind as padding.

17. The device of claim 1, further comprising transport attachments.

18. The device of claim 17, wherein the transport attachments include detachable wheels by which the support and/or blind can be moved on land.

19. The device of claim 17, wherein the transport attachment includes a motor mount for a trolling motor to aid in mobility of the device while in water.

20. The device of claim 17, wherein the transport attachments include loops mounted on a top side where oars or poles can be inserted and retained.

21. A low profile hunting blind system comprising the flotation device of claim 1 and a removable coffin blind which is removably retainable within the opening.
